(19) United States
(12) Patent Application Publication
(10) Pub. No.: US 2007/0087730 A1
(43) Pub. Date: Apr. 19, 2007

(54) Protocol converter

(75) Inventors: Yolius Diroo, San Antonio, TX (US); Edward Walter, Boerne, TX (US); Thomas H. Adams, San Antonio, TX (US); Larry Pearson, San Antonio, TX (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/251,945

(22) Filed: Oct. 17, 2005

(51) Int. Cl. H04M 11/10

(52) U.S. Cl. 455/413

(57) ABSTRACT

The invention provides a system, method and apparatus for connecting a target telephone with Voice Mail System in a network comprising Centrex or other TDM telephones and VoIP (or SIP) type telephones. The invention provides a system for the connection of a target telephone with a Voice Mail System in a network using a protocol converter that is connectable to a PSTN network and an IP network and a voice mail system. The converter may comprise instructions; computer memory and a processor. The converter converts message signals between SIP signals and SMDI signals as may be required and then directs the message signals to a target telephone, which may be through an IP Gateway. The system may further comprise a management console or an end office facility. An Electronic Numbering facility comprising phone numbers convertible between PSTN numbers and SIP numbers may also be provided with the system.

### BACKGROUND OF THE INVENTION

1. Field of the Invention

The present invention relates in general to the field of telecom signaling and protocol conversion.

2. Description of the Related Art

With Voice over IP (VoIP) services on the rise, many businesses are looking to migrate from the traditional phone service to the new VoIP service. These same businesses often have invested in Customer Premises Equipment (CPE) based voice mail systems and so generally would like to continue utilizing during this equipment during and after the migration.

Normally businesses that migrate to VoIP service perform the migration in multiple phases, which will require some of their users to remain on the traditional phone service (i.e. Centrex or other central office-based business legacy communications system that provides direct dialing capability and advanced calling features that may be found on an onsite Private Branch Exchange (PBX)), and others of their users to migrate to the new service (VoIP). Problems may occur when two separate and different networks (e.g., Internet Protocol (IP) and Time Division Multiplex (TDM)) are required to communicate to the same CPE based voice mail system.

There is a need for an apparatus, system and method in VoIP networks that allows for efficient and transparent migration of signaling between types of communication systems, and enables coexistence of legacy systems with VoIP networks. The present invention addresses this need.

### SUMMARY OF THE INVENTION

The invention provides a system, method and apparatus for connecting a target telephone with Voice Mail System in a network comprising Centrex or other TDM telephones and VoIP (or SIP) type telephones and providing MWI signals. The invention provides a system for connection of a target telephone with a Voice Mail System in a network using a protocol converter that is connected to a PSTN network and an IP network and a voice mail system. The converter may comprise instructions; computer memory and a processor. The converter converts message signals between SIP signals and SMDI signals as may be required and then directs the message signals to a target telephone or IP Telephony Call Control Feature Server, which may be through an IP Gateway. The system may further comprise a management console or an end office facility. An Electronic Numbering facility comprising phone numbers convertible between PSTN numbers and SIP numbers may also be provided with the system.

Examples of the more important features of the invention have been summarized (albeit rather broadly) in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE FIGURES

Features of the present invention will become apparent from the following detailed description considered in connection with the accompanying drawings disclosing embodiments of the present invention. It should be understood, however, that the drawings are designed for the purpose of illustration only and not as a definition of the limits of the invention. For a detailed understanding of the present invention, references should be made to the following detailed description of an exemplary embodiment, taken in conjunction with the accompanying drawings, in which like elements have been given like numerals in the drawings, wherein similar reference characters denote similar elements throughout the several views:

FIG. 1 illustrates an example of a TDM system;

FIG. 2 illustrates a system for delivering a Message Waiting Indicator;

FIG. 3 illustrates an embodiment of a Protocol Converter;

FIG. 4 is a schematic illustration of a system provided by the present invention;

FIG. 5 is a ladder diagram that illustrates a scenario where a caller calls and leaves a message for a Centrex phone;

FIG. 6 illustrates how the Centrex Phone subscriber of FIG. 5 calls to retrieve a message;

FIG. 7 is a ladder diagram that illustrates a scenario where a caller calls and leaves a message for an SIP Phone (a VoIP phone); and

FIG. 8 illustrates how the SIP Phone subscriber of FIG. 7 calls to retrieve the messages.

While the invention will be described in connection with its preferred embodiments, it will be understood that the invention is not limited thereto. It is intended to cover all alternatives, modifications, and equivalents that may be included within the spirit and scope of the invention, as defined by the appended claims.

### DETAILED DESCRIPTION OF THE INVENTION

In view of the above, the present invention through one or more of its various aspects and/or embodiments is presented to provide one or more advantages, such as those noted below. The present invention provides for integration of legacy PSTN telephone systems and equipment with VoIP equipment and network infrastructure.

Telephone companies often only allow certain messages to be delivered outside of their network to establish a call from one party to another. For example a telephone company may allow other communication service providers, such as VoIP providers, to purchase True IP to Public Switched Telephone Networks (PSTN), also known as TIPToP trunks, or Competitive Local Exchange Carriers (CLECs) to purchase Feature Group D (FGD) trunks to connect to a telephone company's network. These providers may also be required to connect to an SS7 network for signaling. These trunks, TIPToP, FGD and SS7 generally provide sufficient information and connection to establish the end to end call. However, some important signaling information such as the Message Waiting Indicator (MWI), is filtered and is not delivered to any other parties except internally to telephone company end users who are on the company's own network.

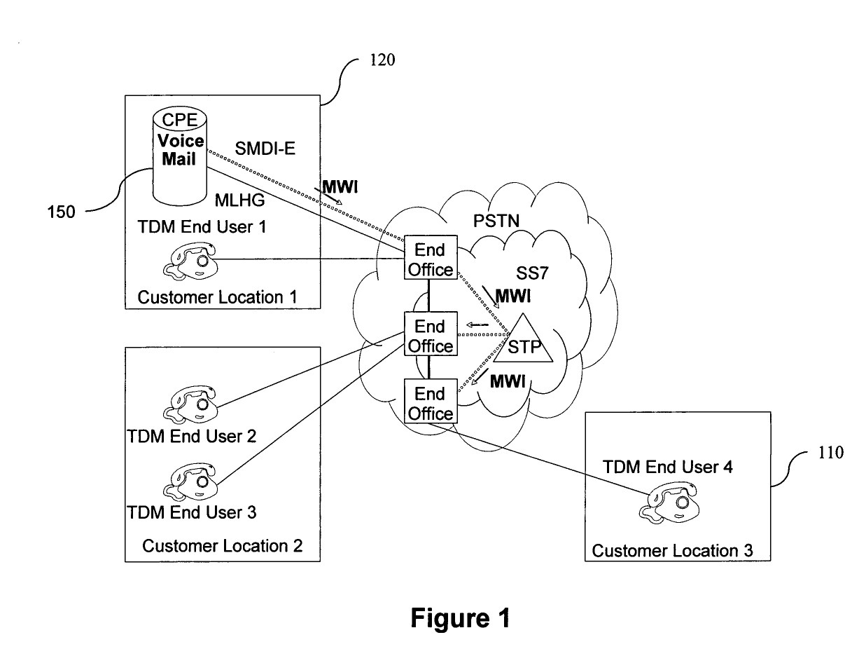

FIG. 1 illustrates an example of a TDM system. In one scenario under this systems a calling, party TDM End User 4, 110 at Customer Location 3 places a call to a TDM End User 1 120 at Customer Location 1 and the telephone line is busy or there is no answer. The end user Voice Mail of the CPE system at Customer Location 1 forwards the call to the Voice Mail Provider's (VMP) multi-line hunt group (MLHG) telephone number equipped with Simplified Message Desk Interface (SMDI) or Simplified Message Desk Interface-Expanded (SMDI-E). SMDI-E separates the call history detail from the voice path and passes both to the VMP. When the VMP platform (which may include a Voice Mail System) receives the data and voice over these two paths, the Customer Provided Equipment 150 synchronizes the data and voice, first to the proper mailbox, and second, to allow the voice message from the caller to be recorded into the mailbox. SMDI-E sends information to the TDM customer's Voice Mail system, before the call is answered, to direct the call to the End User's mailbox. The calling party is routed to the TDM customer's Voice Mail System (VMS). The VMS connects the calling party to the end user's mailbox and answers with the personal greeting recorded by the end user. The VMS sends a message to the SMDI-E to activate the MWI if a message is left in the mailbox. Public Switch Telephone Network (PSTN) Central Office switch provides an audio or visual MWI (which may be by Frequency Switched Key (FSK)) on the end user's telephone line. The end user lifts the receiver to hear the stutter dial tone, or sees the message status lamp illuminated and calls the VMS to retrieve the message(s) by, for example, keying in a Personal Identification Number (PIN) upon accessing the VMS. The VMS then sends a message to SMDI-E to deactivate the MWI when all of the new messages have been retrieved.

The filtering of the Transaction Capability Application Part (TCAP) MWI SS7 signal is done primarily due to the fact that some telephone companies do not want to open their SS7 network except to some limited extents. To resolve this issue, new network equipment is provided by the present invention enables delivery of an MWI message to an IP phone outside of a SS7 network.

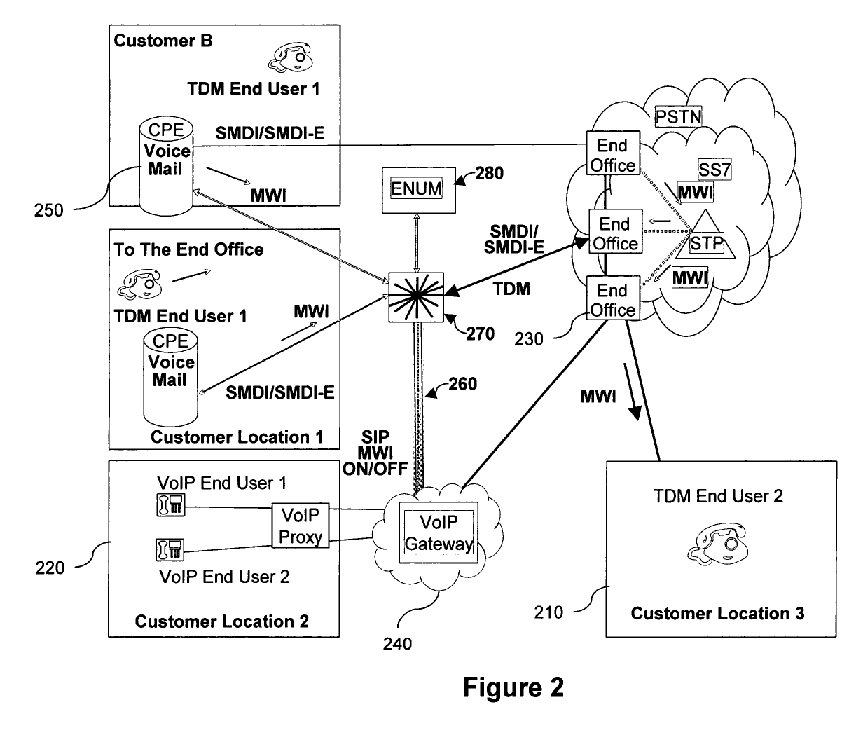

FIG. 2 illustrates an embodiment of the present invention that provides a phased approach migration method, enabling the customer to utilize legacy TDM equipment and newer VoIP equipment together. CPE based voice mail systems (250) are enabled to provide the customer with MWI signaling on both VoIP phones and TDM phones. The invention, comprising a Protocol Converter, provides for equipment with the functionality of a router and a gateway. The protocol converter routes signals to the appropriate network and/or CPE, for example in a TDM network or IP network, and converts MWI signals as required so that telephone users will receive an MWI notification whether their phones are IP Network phones or not.

The Protocol Converter may be installed in a telephone company's network, on the customer's premises as a CPE or installed in conjunction with any other network, and may be transparent to the subscriber or end user from the functionality point of view. When a message from a TDM system is destined to a VoIP end user, the Protocol Converter converts the signal to an IP type signal, i.e. SIP (Session Initiation Protocol) and the MWI signal is routed to the VoIP network. When the message is destined to the TDM end user, the Protocol Converter will route the MWI signal to the TDM network, and likewise converts the signals as and when necessary.

A method provided by an embodiment of the present invention for delivering a MWI to customers that are migrating in phases from the traditional phone services to VoIP services is illustrated in FIG. 2. The Protocol Converter provides for converting the TDM type signaling such as SMDI/SMDI-E for MWI to IP signaling such as H.323, SIP and etc, and then provides for routing the signal to the appropriate network.

For example, TDM end user 2 210 from Customer Location 3 is calling one of the IP end users in Customer Location 2 (220). The TDM call will travel to the local end users End Office 230. An End Office is a location where carriers place telecom equipment closest to the customer. Typically, this is where customers are provisioned. Class 5 switches are typically located here. A Local End Office 230 may determine the call is an IP call and will deliver the call to the IP Customer. The IP Customer will then deliver the call to their end user 220. The IP end user does not answer the call; therefore, the call is forwarded via Call Forward Busy Line/Don't Answer (CFBL/DA) feature assignment in the end user's IP network and is routed to VoIP Gateway 240. The VoIP Gateway forwards the message via the IP connection 260 to the customer's voicemail system 250.

TDM end user 2 210 leaves a message and hangs up. An MWI message is sent from the voicemail system to the Protocol Converter 270. The Protocol Converter 270 forwards the signal through gateway 240 to the IP customer's “Softswitch” or SIP Proxy Server, illustrated here within Customer Location 2 220 and labeled ‘VoIP Proxy.’ In this way, an MWI is delivered to the appropriate IP end user. The same path will be taken if the IP end user in Customer Location 2 220 calls another IP end user in the same location.

An SIP Proxy Server (or softswitch) is a call control software package for use in building Voice over IP networks. Based on the Session Initiation Protocol (SIP), an SIP Proxy provides a full array of call routing and signaling capabilities in packet voice networks. A softswitch may also be called a Proxy, Proxy Gatekeeper, Call Server, Call Agent, Media Gateway Controller, or Switch Controller. Software used to bridge a public switched telephone network and voice over Internet by separating the call control functions of a phone call from the media gateway (transport layer). Softswitch performs call control functions such as protocol conversion, authorization, accounting and administration operations.

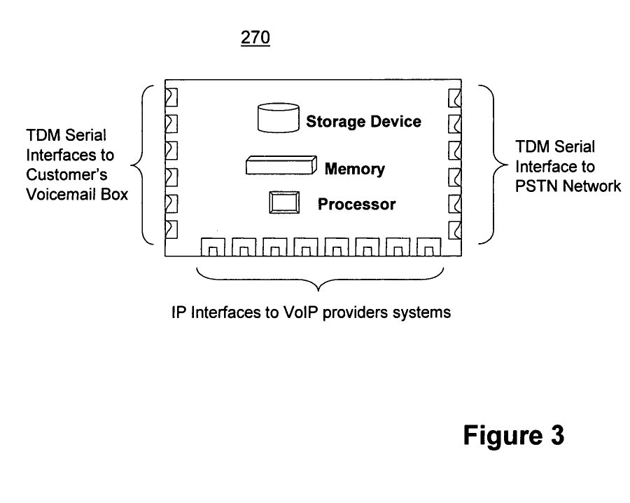

An embodiment of the Protocol Converter is illustrated in FIG. 3. The Protocol Converter may provide interfaces to connect to a Customer's voicemail system, a PSTN network and a VoIP network. Additionally, the Protocol Converter may have a storage device, memory and processor.

The Protocol Converter can use customer specific information. For example the Protocol Converter may have a table with customers IP and TDM phone numbers in which the MWI may be routed via the appropriate interface to the correct network. See Table 1 below for examples. The Protocol Converter may have multiple tables for multiple different customers.

TABLE 1

| | | Customer Number 1 | |
|---|---|---|---|
| | | Telephone # | Destination |
| | | 210-886-1234 | Serial 0 |
| | | 210-886-4567 | Serial 1 |
| PSTN Phone Number | {open oversize brace} | 210-886-8901 | Serial 2 |
| | | 210-886-2345 | Serial 3 |
| | | 210-999-4567 | IP 1 |
| | | 210-999-2345 | IP 2 |
| VoIP Phone Number | {open oversize brace} | 210-999-6543 | IP 3 |
| | | 210-999-9876 | IP 4 |

The Protocol Converter may also utilize a table that is associated with a lookup of NPA-NNX (Area Code and Exchange) and CLLI (Common Language Location Code). The CLLI code represents the switch End Office or VoIP's Softswitch as illustrated with Table 2.

TABLE 2

| | | NPA-NNX | CLLI | Destination |
|---|---|---|---|---|
| | | 210-886 | XYZ | Serial 0 |
| | | 210-886 | WPA | Serial 1 |
| PSTN Phone Number | {open oversize brace} | 210-886 | NWA | Serial 2 |
| | | 210-886 | RZQ | Serial 3 |
| | | 210-999-4567 | AAA | IP 1 |
| | | 210-999-2345 | BBB | IP 2 |
| VoIP Phone Number | {open oversize brace} | 210-999-6543 | CCC | IP 3 |
| | | 210-999-9876 | DDD | IP 4 |

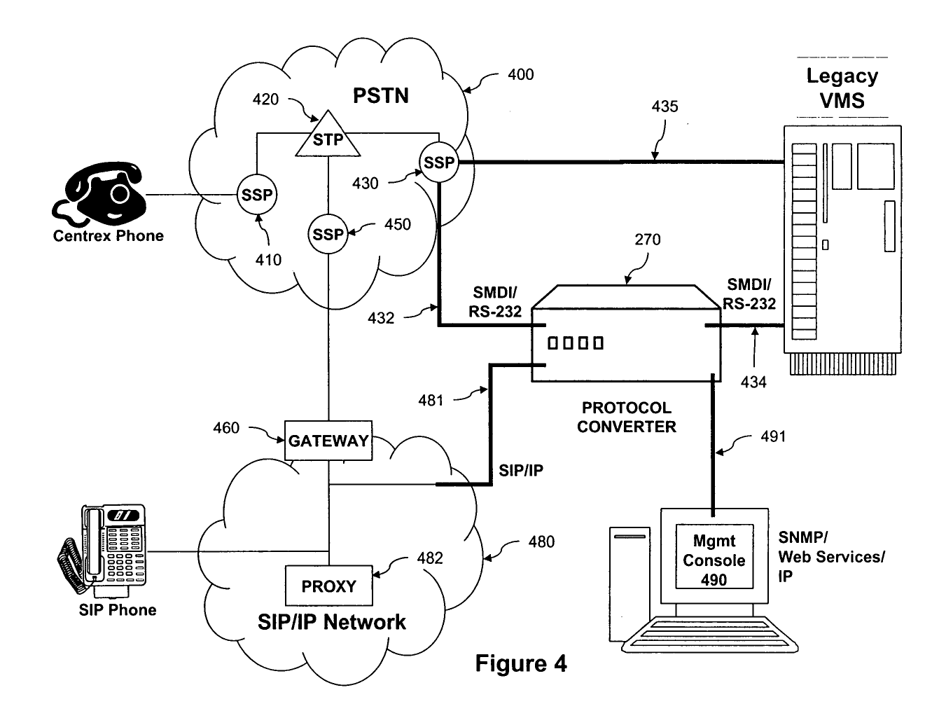

The Protocol Converter may be connected to the ENUM 280 (an Electronic Numbering facility that has information exemplified in Tables 1 and 2) as illustrated in FIG. 2, which may be resident on the protocol converter or a management console 480 as illustrated in FIG. 4. Alternatively the ENUM 280 may be connected to the protocol converter and reside on a PSTN or IP network. ENUM's functionality is to enable conversion of an IP telephone number to a PSTN telephone number and a PSTN telephone number to an IP telephone number. Once the protocol conversion has taken place, ENUM derived information is used to determine a target telephone to deliver the MWI signal, either to the IP telephone or the TDM telephone.

A schematic illustration of a system provided by the present invention is presented in FIG. 4. A Centrex Phone and an SIP Phone both share a Legacy VMS. The Centrex Phone is connected to a PSTN network 400 at a Service Switching Point (SSP) 410 through at least one Signal Transfer Point (STP) 420, which are usually deployed in pairs and switch messages between SSPs. Another SSP 430 may interface with a communication line 435, which may be a communication line to a Legacy VMS. These communication lines may include a T1 line, T3 line, Primary Rate Interface (PRI) ISDN line, an independent analog phone line (POTS) line or TDM circuit for carrying multiple data or voice DS0 transmissions between 2 physical locations. Also, SMDI signals may be transferred from SSP 430 to Protocol Converter 270 by way of a communication line connection, for example, to an RS-232 connection on the Protocol Converter. There may be a further RS-232 connection for the communication line from Protocol Converter 270 to the Legacy VMS. Signals may leave PSTN 400 directly by way of SSP 450 (or any other SSP) to go to Gateway 460 and enter the IP Network 480.

Protocol Converter 270 connects to IP Network 480 and may also connect 491 to a management console 490 that facilitates Simple Network Management Protocol (SNMP) and Web Services. Protocol Converter 270 connects 481 to IP Network 480 to communicate with (softswitch) proxy 482 and/or the SIP Phone.

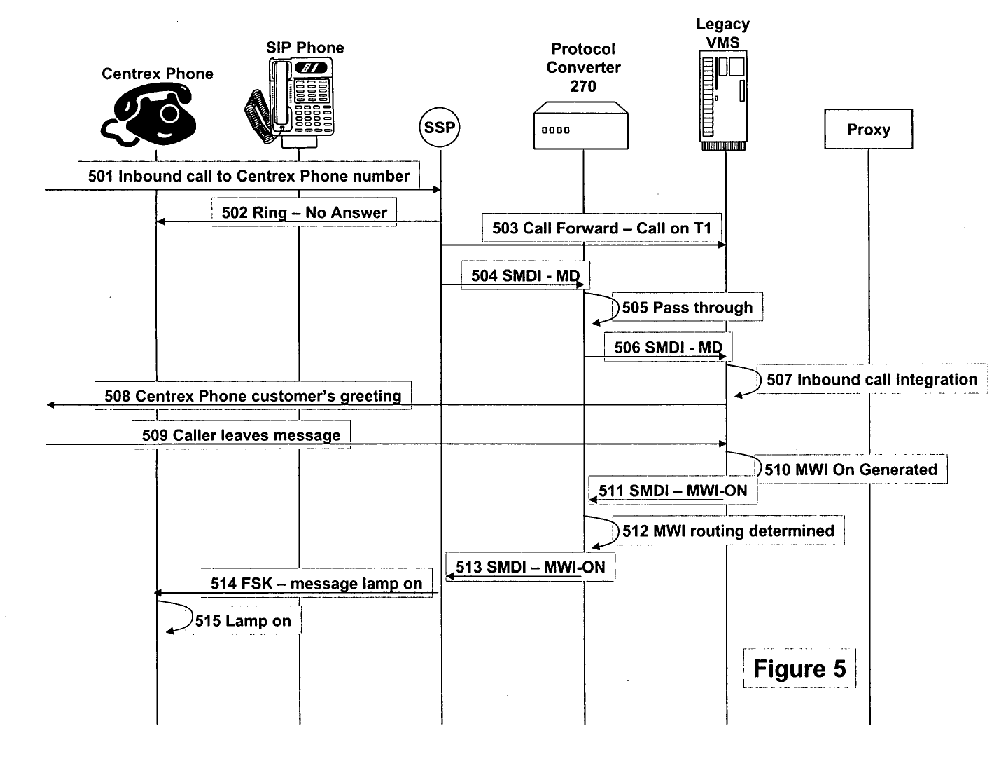

FIGS. 5, 6, 7 and 8 are ladder diagrams that highlight the call flow steps for the signaling aspect of the telephone calls (as opposed to the voice path). FIG. 5 is a ladder diagram that illustrates a scenario where a caller calls and leaves a message for a Centrex phone. An inbound call arrives at an SSP to the Centrex Phone number 501. The phone rings and there is no answer 502. The call is forwarded (for example on TDM circuit 435) to the Legacy VMS 503. At the same time, the SMDI-MD message may be routed on the SMDI circuit (432 and/or 434 of FIG. 4) to the Protocol Converter 504, where it is passed through 505 unchanged and then arrives 506 at the Legacy VMS. The inbound call is integrated 507 and Centrex Phone customer's greeting 508 is delivered for the caller. The caller leaves a message 509 on the Legacy VMS which generates an MWI-ON message 510 that is delivered to the protocol converter 511 where routing is determined 512 for the MWI message. The MWI message is delivered to an SSP 513 and the Frequency Shift Keyed data for turning on a lamp is sent to the Centrex Phone 514, and the lamp is illuminated 515.

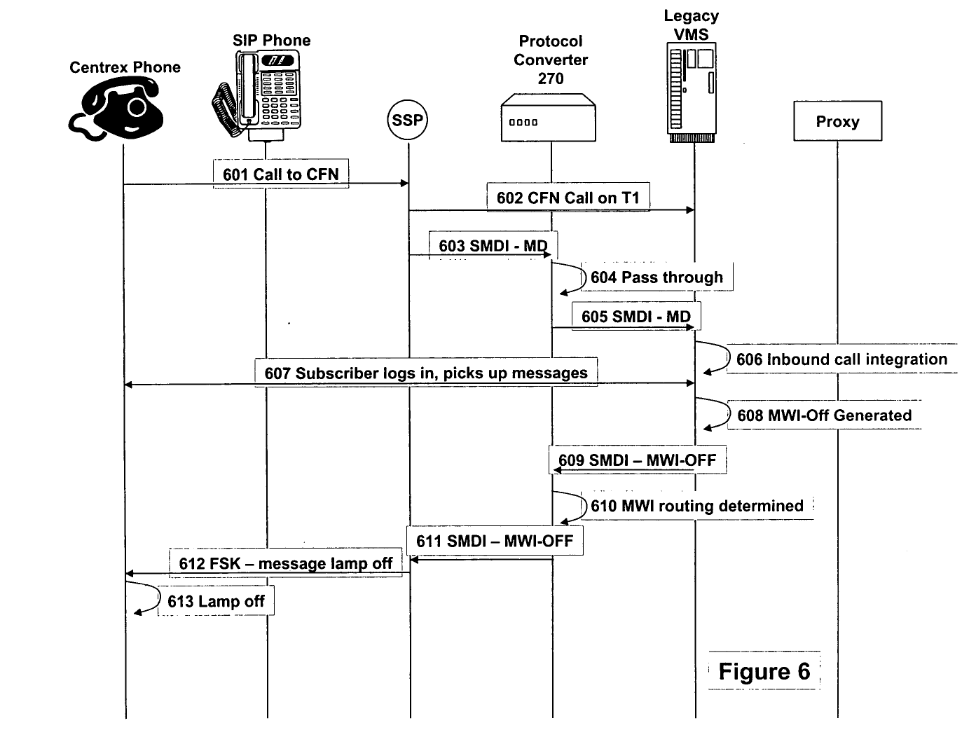

FIG. 6 then illustrates how the Centrex Phone subscriber of FIG. 5 calls to retrieve the message. The Centrex Phone subscriber calls to the Call Forward Number (CFN) 601 which arrives at an SSP and the call is routed 602 to the Legacy VMS. At the same time the SMDI information is routed to the protocol converter 603 where it is passed through 604 to the Legacy VMS 605. Inbound call integration 606 occurs and the Centrex Phone Subscriber logs in and picks up any messages 607. When all the messages are picked up, an MWI-Off is generated 608 and the SMDI message is sent to the protocol converter 609 where the routing is determined 610 and the message sent 611 to an SSP. Then the FSK message lamp off signal is sent to the Centrex Phone 612 and the lamp is extinguished 613.

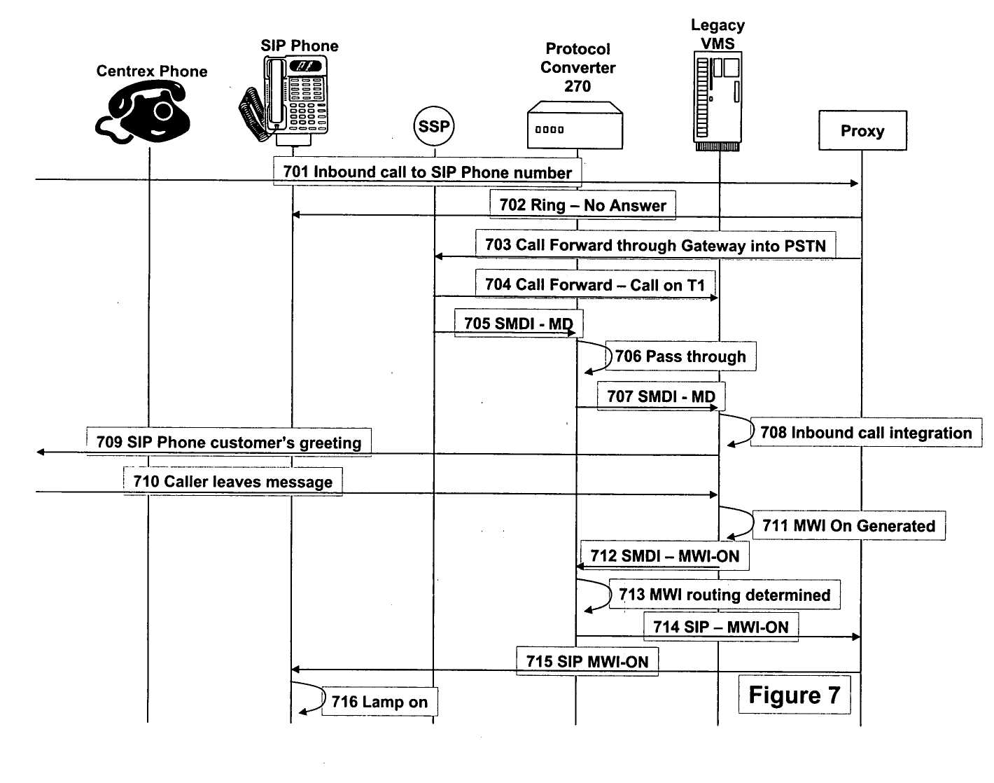

FIG. 7 is a ladder diagram that illustrates a scenario where a caller calls and leaves a message for an SIP Phone (a VoIP phone). An inbound call is routed to an SIP Phone number 701 and arrives at the softswitch or Proxy. When there is no answer 702 on the SIP Phone, the call is forwarded through a Gateway (e.g., 460) into a PSTN 703 at an SSP. The call is forwarded 704 to the Legacy VMS while the SMDI information is routed 705 to the protocol converter, passed through 706, and sent on to the Legacy VMS 707. The inbound call is integrated 708 and the SIP Phone customer's greeting is delivered to the caller 709. The caller leaves a message 710 which generates 711 a MWI-On signal that is routed to the protocol converter 712. The MWI routing is determined at the Protocol Converter, 713, and since the call is for an SIP Phone, the SIP MWI-On signal is delivered to the Proxy 714 and then sent to the SIP Phone 715 where the lamp is illuminated 716.

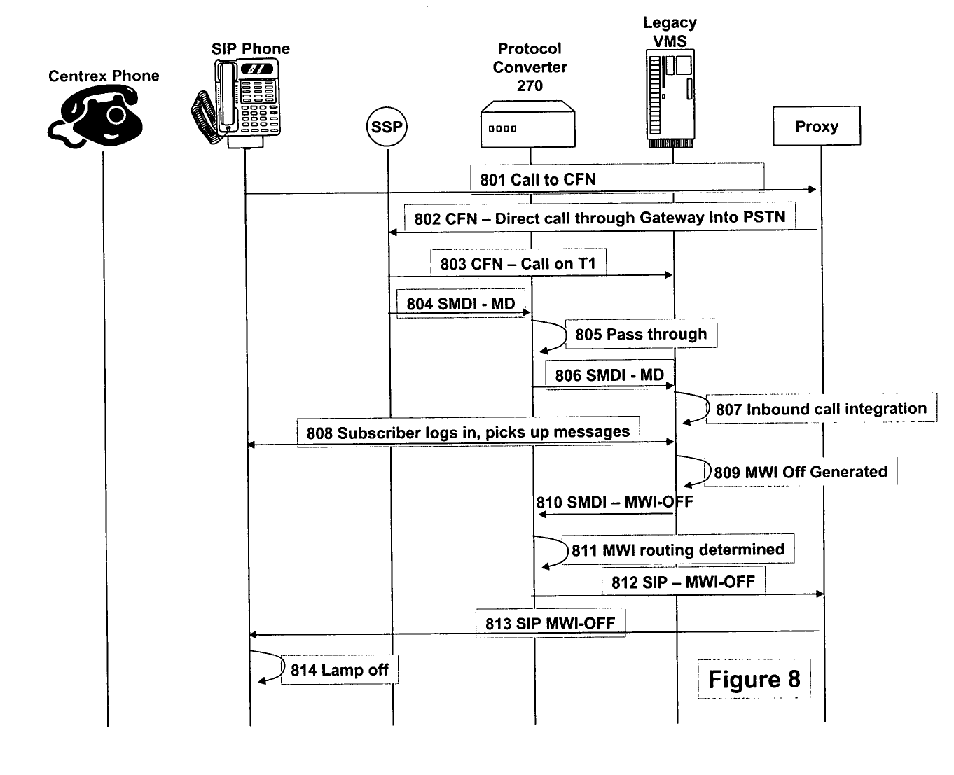

FIG. 8 illustrates how the SIP Phone subscriber of FIG. 7 calls to retrieve the messages. The voice path from the SIP Phone (RTP stream) does not pass through the Proxy on it way through the gateway to the SSP. The VoIP voice path is from the SIP phone to the Gateway where it is converted to TDM/Analog and put on a phone line connected to the PSTN. SIP Phone subscriber calls 801 to CFN which is routed through the Gateway 802 into the PSTN and then an SSP. The call is routed 803 from an SSP to the Legacy VMS. At the same time, the SMDI signal is routed 804 to the Protocol Converter, passed through 805, and the signal sent on 806 to the Legacy VMS. The inbound call is integrated 807, the subscriber logs in and picks up any messages 808, and when all the new messages are retrieved an MWI-Off signal is generated 809. The SMDI MWI-Off signal is routed 810 to the Protocol Converter where the signal routing determination 811 is made to send the MWI-Off signal to the Proxy 812. From the Proxy, the MWI-Off signal is sent 813 to the SIP Phone where the lamp is extinguished 814.

The invention provides a system, method and apparatus for connecting a target telephone with Voice Mail System in a network comprising Centrex or other TDM telephones and VoIP (or SIP) type telephones. The invention provides a system for the connectability of a target telephone with a Voice Mail System in a network using a protocol converter that is connectable to a PSTN network and an IP network and a voice mail system. The converter comprises machine readable instructions; computer memory and a processor. The converter converts message signals between SIP signals and SMDI signals and then directs the message signals to a target telephone, which may be through a VoIP Gateway. The system may further comprise a Voice Mail System, a management console or an end office facility. An Electronic Numbering facility comprising phone numbers convertible between PSTN numbers and SIP numbers may also be provided with the system.

In another embodiment the invention provides an apparatus for connecting a target telephone and a Voice Mail System to a network comprising interfaces for connecting the apparatus to a PSTN network, an IP network and a Voice Mail System. Computer readable instructions are provided for converting signals between SMDI signals and SIP signals to obtain converted signals. The converted signals are then directed to the target telephone. The apparatus may comprise computer memory, a storage device and a processor. The apparatus may comprise and/or be connected to a management console as well as an IP Gateway. Connections may include serial ports or connectors like an RS-232.

In another embodiment provided by the present invention, a computer readable medium contains instructions that when executed by a computer perform a computerized method for connecting a Voice Message System to a target telephone. This includes routing a telephone call forwarded in conjunction with a called target telephone to a Voice Message System and routing an SMDI message associated with the telephone call to a Protocol Converter. The Protocol Converter converts the SMDI message to an SIP message when the target telephone is an SIP Phone. The SIP message is then directed to the target telephone when the target telephone is an SIP Phone. An Electronic Numbering facility may be provided that comprises phone numbers convertible between PSTN numbers and SIP numbers. The method may further comprise routing converted messages through an IP Gateway to the target telephone.

Still another embodiment provided by the present invention is for a network wherein telephone calls are forwarded to a Voice Message System, a method for routing MWI messages to a target telephone, comprising routing a telephone call forwarded in conjunction with a called target telephone to a Voice Message System and routing the telephone call SMDI message to a Protocol Converter. The Protocol Converter converts the SMDI message to an SIP message when the target telephone is an SIP Phone and routes the SIP message to the target telephone.

In another aspect the present invention provides a set of application program interfaces embodied on a computer readable medium for execution on a computer in conjunction with an application program that routes a telephone call forwarded in conjunction with a called target telephone to a Voice Message System. The invention comprises a first interface that receives an SMDI message input from a Voice Message System, a second interface that converts an SMDI message to an SIP message, and a third interface that routes an SIP message or an SMDI message to the target telephone. A fourth interface is provided for receiving input from a softswitch proxy. A fifth interface is provided for receiving input from a PSTN Network. A sixth interface is provided for receiving input from a management console. A seventh interface is provided for receiving input from an IP Network Gateway. An eighth interface is provided for input from an Electronic Numbering facility comprising phone numbers convertible between PSTN numbers and SIP numbers.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

What is claimed is:

1. A system for directing messages between a target telephone and a Voice Mail System in a network comprising:
a protocol converter that:
i) is connected to a PSTN network and an IP network and a voice mail system;
ii) comprises computer readable instructions; computer memory and a processor; and
iii) converts an SMDI message to an SIP message and directs the SIP message to the target telephone.

2. The system of claim 1 further comprising a VoIP Gateway.

3. The system of claim 1 further comprising a management console.

4. The system of claim 1 further comprising an end office facility.

5. The system of claim 1 further comprising an Electronic Numbering facility comprising phone numbers convertible between PSTN numbers and SIP numbers.

6. An apparatus for directing messages between a target telephone and a Voice Mail System comprising:
(a) interfaces for connecting the apparatus to a PSTN network, an IP network and a Voice Mail System;
(b) computer readable instructions to convert an SMDI message to an SIP message and direct the SIP message to the target telephone;
(c) computer memory; and
(d) a processor.

7. The apparatus of claim 6 further comprising a management console.

8. The apparatus of claim 6 further comprising an IP Gateway.

9. The apparatus of claim 6 wherein at least one interface comprises an RS-232 serial connector.

10. The apparatus of claim 6 further comprising an Electronic Numbering facility comprising phone numbers convertible between PSTN numbers and SIP numbers.

11. A computer readable medium containing instructions that when executed by a computer perform a computerized method for delivering a message associated with a Voice Message System to a target telephone comprising:
(a) routing an SMDI message associated with a telephone call forwarded in conjunction with a target telephone to a Voice Message System;
(b) routing an SMDI message associated with the telephone call to a Protocol Converter;
(c) converting the SMDI message, using the Protocol Converter, to an SIP message when the target telephone is an SIP Phone; and
(d) directing the SIP message to the target telephone when the target telephone is an SIP Phone.

12. The medium of claim 11, wherein the method further comprises an Electronic Numbering facility comprising phone numbers convertible between PSTN numbers and SIP numbers.

13. The medium of claim 11, wherein the method further comprises routing converted messages through an IP Gateway to the target telephone.

14. In a network wherein telephone calls are forwarded to a Voice Message System, a method for routing messages to a target telephone, comprising:
(a) routing an SMDI message associated with the forwarded call to a Protocol Converter;
(b) converting the SMDI message, using the Protocol Converter, to an SIP message when the target telephone is an SIP Phone; and
(c) directing the SIP message to the target telephone.

15. The method of claim 16 further comprising routing an SMDI message associated with a telephone call forwarded in conjunction with the target telephone to a Voice Message System;

16. A set of application program interfaces embodied on a computer readable medium for execution on a computer in conjunction with an application program that routes an SMDI message associated with a telephone call forwarded in conjunction with a called target telephone to a Voice Message System, comprising:
(a) a first interface that receives an SMDI message input from a Voice Message System;
(b) a second interface that converts an SMDI message to an SIP message; and
(c) a third interface that routes an SIP message or an SMDI message to the target telephone.

17. The set of application program interfaces of claim 16 further comprising: a fourth interface for receiving input from a softswitch proxy.

18. The set of application program interfaces of claim 16 further comprising: a fifth interface for receiving input from a PSTN Network.

19. The set of application program interfaces of claim 16 further comprising: a sixth interface for receiving input from a management console.

20. The set of application program interfaces of claim 16 further comprising: a seventh interface for receiving input from an IP Network Gateway.

21. The set of application program interfaces of claim 16 further comprising: an eighth interface for input from an Electronic Numbering facility comprising phone numbers convertible between PSTN numbers and SIP numbers.
